(19) United States
(12) Patent Application Publication
(10) Pub. No.: US 2012/0152381 A1
(43) Pub. Date: Jun. 21, 2012

(54) MODULAR CONTROL SYSTEM FOR FLUIDIC CONTROL DEVICES

(76) Inventors: Michael Ungerer, Forchtenberg (DE); Florian Krämer, Niedernhall (DE); Tina Brinzing, Kunzelsau (DE); Christof Jacob, Ohringen (DE); Marcus Keinath, Forchtenberg (DE); Markus Feinauer, Braunsbach (DE); Stefan Elmer, Ditzingen (DE); Peter Hofmann, Grafenau (DE)

(21) Appl. No.: 13/377,281

(22) PCT Filed: Jun. 8, 2010
(86) PCT No.: PCT/EP10/03429

§ 371 Date: Mar. 2, 2012

(30) Foreign Application Priority Data
Jun. 10, 2009 (DE) 20 2009 008 054.4

(51) Int. Cl. F16K 37/00; F17D 3/00

(52) U.S. Cl. 137/552

(57) ABSTRACT

A modular checking system for fluidic control devices has a display and/or operating unit which includes an inductive interface. The display and/or operating unit is adapted to be detachably connected to a fluidic control device in such a relative position to the latter that the inductive interface is coupled to a corresponding interface of the control device. Encoded signals can be transmitted via the inductive interfaces, the signals containing both information and energy from the control device to the display and/or operating unit for operating the latter.

The present invention relates to a modular checking system for fluidic control devices which includes at least one display and/or operating unit and a fluidic control device.

In industrial facilities, frequently a large number of different fluidic control devices such as valves, regulators or sensors are arranged where different settings or inspections such as device configuration, calibration, status, checking of measured values, and others are performed during a process. To this end, all of the individual devices are frequently fitted with display and/or operating units, or the devices feature mounting fixtures for the display and/or operating units which are suitably adapted, depending on the type, size and interface thereof.

The checking system according to the invention is of a modular design, as indicated in claim 1. It consists of at least one display and/or operating unit and is detachably connected to a fluidic control device. The display and/or operating unit is coupled to the fluidic control device by means of an inductive interface. Advantageous embodiments are indicated in the dependent claims.

Inductive interfaces are known and are realized, for example, by means of a coil system and a ferrite core.

The display and/or operating unit is supplied with energy by the fluidic control device via the inductive interface. An additional external voltage supply is thereby dispensed with. Furthermore, encoded signals can be transmitted for information transfer. It is of advantage that the transfer of energy and data occurs in a wireless manner, which contributes to an enhanced clarity in the system because the number of cables required is reduced.

It is particularly advantageous to provide the display and/or operating unit with an energy storage element. This allows both components of the modular checking system to be operated as separate devices and independently of each other. The energy storage element is charged as soon as the display and/or operating unit is connected to the fluidic control device or to a charging station. In this way, a data manipulation or evaluation can be effected on the display and/or operating unit without an external voltage supply and without contact with the fluidic control device.

In addition, it has turned out to be convenient to produce the detachable connection between the display and/or operating unit and the fluidic control device by means of permanent magnets. To this end, at least two permanent magnets are mounted in each of the two components of the modular checking system in such a way that they are located opposite each other in the checking system, the magnets in the fluidic control device having the opposite polarization direction in relation to those in the display and/or operating unit. The permanent magnets are disposed at a distance from the inductive interfaces so as not to adversely affect the latter.

The permanent magnets allow an automatic alignment of the inductive interfaces, as a result of which an optimum positioning thereof is achieved, along with a low-loss energy transfer.

Energy and information can be transmitted between the display and/or operating unit and the fluidic control device by means of signals which are preferably modulated according to Miller encoding to avoid energy transfer gaps. The transfer of information can be effected bidirectionally.

The display and/or operating unit can be coupled to different fluidic control devices such as regulators, sensors, valves, without a special mounting device having to be provided for this purpose.

With the aid of the modular checking system described, different fluidic control devices can be put into operation, configured or calibrated by one single display and/or operating unit. Data from the different fluidic control devices can be read out successively and stored to be subsequently evaluated or manipulated in a place that is spatially separate from the control devices. Using the display and/or operating unit, it is also possible to install software updates to the fluidic control devices in a simple way.

Further advantages and embodiments of the invention will be described with reference to the accompanying Figures, in which:

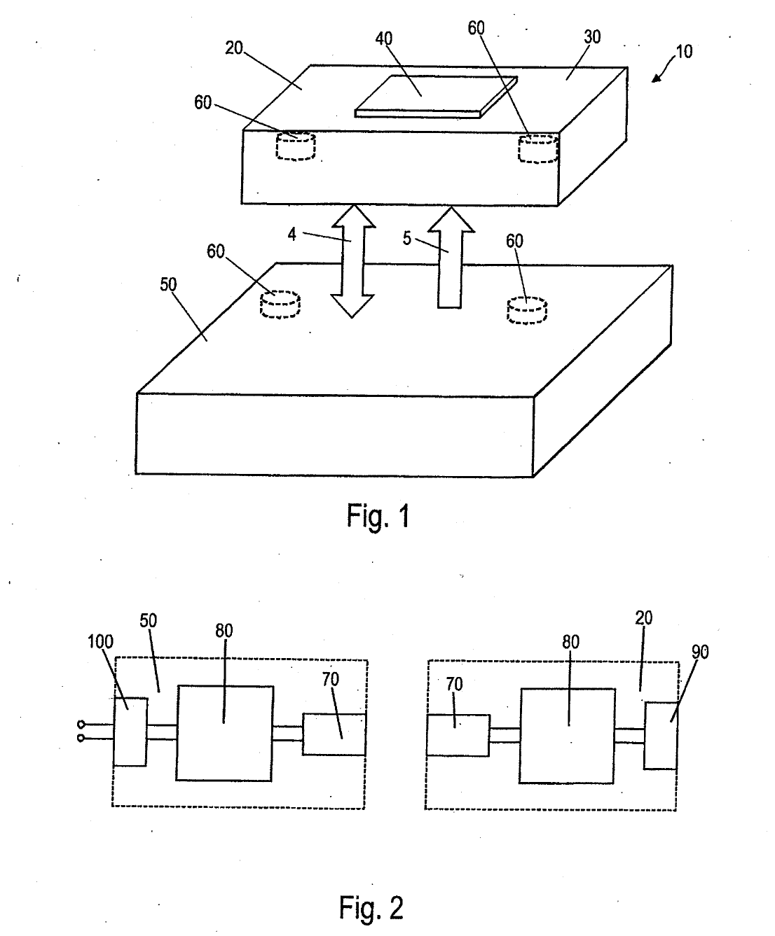

FIG. 1 shows a schematic exploded view of the modular checking system for fluidic control devices;

FIG. 2 shows a schematic diagram of an exemplary embodiment of the modular checking system.

FIG. 1 shows a schematic exploded view of the modular checking system 10, consisting of a display and/or operating unit 20 having an upper side 30 which includes a display device such as, for example, a display 40, and a fluidic control device 50.

Permanent magnets 60 having opposite polarization directions are arranged on opposite sides in both modules, the display and/or operating unit 20 and the fluidic control device 50, so that the two modules can be detachably connected to each other by means of a magnetic force. No special mounting fixture for the display and/or operating unit 20 needs to be provided on the fluidic control device 50. This type of connection of the two modules to each other is substantially independent of their geometric configuration.

As illustrated in FIG. 2, one respective inductive interface 70 is arranged on opposite sides of the display and/or operating unit 20 and the fluidic control device 50 in the modular checking system 10. The inductive interfaces 70 are adapted to be coupled to each other and are connected to associated electronic drive systems 80.

The display and/or operating unit 20 includes an energy storage element 90 such as an accumulator or a battery, whereas the fluidic control device 50 is connected to an external voltage supply 100. As soon as the display and/or operating unit 20 is connected to the fluidic control device 50, an energy transfer takes place via the inductive interfaces 70, and the display and/or operating unit 20 can thus be operated.

Preferably, the energy storage element 90 is an accumulator which is charged concurrently in the contact situation of the display and/or operating unit 20 and the fluidic control device 50. This allows the two components, the display and/or operating unit 20 and the fluidic control device 50, to be operated self-sufficiently and independently of each other if the energy storage element 90 is charged. The process of charging the display and/or operating unit 20 may, of course, take place not only at the fluidic control device 50, but also at any other desired charging station. As a result, evaluations of measured data transmitted to the display and/or operating unit 20 can be carried out in a place that is spatially separate from the fluidic control device 50, for example.

The inductive interfaces 70 on opposite sides of the display and/or operating unit 20 and the fluidic control device 50 are automatically aligned by means of the permanent magnets 60, resulting in an optimum positioning of the inductive interfaces and, thus, in a low-loss energy transfer. Furthermore, the permanent magnets 60 are arranged in the checking system for fluidic control devices 10 in such a way that they are remote from the inductive interfaces 70, formed from a coil system with a ferrite core, so that the latter are not adversely affected.

In the modular checking system for fluidic control devices 10, energy and information between the display and/or operating unit 20 and the fluidic control device 50 are transmitted via the inductive interfaces 70 by means of signals that are preferably modulated according to Miller encoding. This type of signal encoding has the advantage that upon an occurrence of several zero bits in succession, there will be no undesirable energy transfer gap.

A further advantage of the checking system 10 according to the invention for fluidic control devices is that the same display and/or operating unit 20 can be used for different fluidic control devices 50 such as regulators, sensors, valves and others, and that it is not required to make a separate display and/or operating unit available for each fluidic control device.

1. A modular checking system for fluidic control devices, comprising at least one display and/or operating unit which includes an inductive interface and is adapted to be detachably connected to a fluidic control device in such a relative position to the latter that the inductive interface is coupled to a corresponding interface of the control device, wherein encoded signals can be transmitted via the inductive interfaces, the signals containing both information and energy from the control device to the display and/or operating unit for operating the latter.

2. The modular checking system for fluidic control devices according to claim 1, characterized in that the display and/or operating unit includes an energy storage element.

3. The modular checking system for fluidic control devices according to claim 1, characterized in that the display and/or operating unit and the fluidic control device each include at least two permanent magnets which are arranged opposite each other in the modular checking system and have opposite polarization directions.

4. The modular checking system for fluidic control devices according to claim 3, characterized in that the permanent magnets in the display and/or operating unit and in the fluidic control device are arranged in relation to the inductive interfaces such that the inductive interfaces are automatically aligned relative to each other.

5. The modular checking system for fluidic control devices according to claim 1, characterized in that energy and information can be transmitted between the display and/or operating unit and the fluidic control device by means of signals which are preferably modulated according to Miller encoding.

6. The modular checking system for fluidic control devices according to claim 1, characterized in that the display and/or operating unit is adapted to be coupled to different fluidic control devices such as, for example, regulators, sensors, valves.
